(19) United States
(12) Patent Application Publication
(10) Pub. No.: US 2019/0278025 A1
(43) Pub. Date: Sep. 12, 2019

(54) CONNECTOR LOADER

(71) Applicant: OXFORD FIBER LTD, Rugby (GB)

(72) Inventors: Ian Murgatroyd, Rugby (GB); Edward John Phillip Kearney, Rugby (GB)

(73) Assignee: OXFORD FIBER LTD, Rugby (GB)

(21) Appl. No.: 16/295,698

(22) Filed: Mar. 7, 2019

(30) Foreign Application Priority Data
Mar. 9, 2018 (GB) 1803791.1
Mar. 1, 2019 (GB) 1902805.9

(51) Int. Cl. G02B 6/25; G02B 6/38

(52) U.S. Cl. CPC G02B 6/25; G02B 6/3826; G02B 6/3846

(57) ABSTRACT

A method for terminating an optical fiber in a connector, using a device includes: (a) positioning a stripped external fiber in a fiber retainer slidably attached to the chassis; (b) sliding the stripped fiber and their retainer to a first position closely adjoining the cleaver; (c) cleaving the bare portion of the fiber to form a cleaved end; (d) sliding the fiber retainer away from the cleaver; (e) causing to be presented a connector; (f) sliding the fiber retainer to a second position along the channel of the chassis, thereby causing the cleaved end to extend into the guide of the connector; (g) actuating the connector while the fiber retainer is at the second position to clamp the cleaved end in the connector and optionally crimping a deformable member which acts to further attach the connector to the fiber cable.

### CROSS-REFERENCE TO RELATED APPLICATIONS

This application claims foreign priority benefits under 35 U.S.C. § 119(a)-(d) to GB Application 1803791.1 filed Mar. 9, 2018 and GB Application 1902805.9 filed Mar. 1, 2019, which are hereby incorporated by reference in their entirety.

### TECHNICAL FIELD

Various embodiments of the present invention relate generally to field terminating connectors, and, more specifically, to a single device and simple method for field terminating fibers.

### BACKGROUND

Optical fiber connectors are an essential part of practically all optical fiber communication systems. For instance, such connectors are used to join segments of fiber into longer lengths, to connect fiber to active devices such as radiation sources, detectors and repeaters, and to connect fiber to passive devices such as switches and attenuators. The principal function of an optical fiber connector is to optically couple a fiber with a mating device (e.g., another fiber, an active device or a passive device). This is achieved by holding the end of the fiber in a ferrule such that the core of the fiber is axially aligned with the optical pathway of the mating device.

To facilitate an effective optical coupling, the end face of the ferrule is typically polished. Preparing a polished ferrule is a sophisticated process. It requires cleaving the fibers, terminating them in a ferrule (typically by using an epoxy), and polishing the ferrule to exacting tolerances. Therefore, such a process is usually performed in a controlled setting with precision equipment by skilled personnel. Frequently, however, connectors must be terminated in the field where such facilities and personnel are not available. Under these conditions, it is desirable to omit the step of the polishing the ferrule by instead terminating the external, or field, fiber with a connector which contains within it a fiber stub already terminated in a polished ferrule. Because the ferrule is already polished in a fiber-stub, field-installable connector, field installation requires only optically coupling the external fiber to the fiber stub. This is often done with using a refractive index matched gel to improve optical coupling therebetween.

Connectors are not only used to effect optical joining of a single fiber to a single-fiber connector, but they are known for the joining of multiple fibers to a multiple-fiber connector such as a MT connector, where the multiple fibers, i.e. external field fibers, are often arranged in a ribbon format of 12 or more fibers.

The connector, attached to its fiber or fibers, should satisfy a number of conditions. Firstly, a good optical connector should exhibit low optical loss between the external fiber and the connector, whereby the external and internal fibers are axially aligned with the optical pathway. Secondly, connectorisation of the optical fiber should exhibit low optical back reflection. Because any air-glass interface will reflect 4% of the optical signal passing therethrough, this optical reflection must be prevented from returning down the optical fiber.

Optical back-reflection may be suppressed by the use of index-matching gel but there is always the danger that such gel may fail in use, and so secondary methods should be used to avoid coupling of any back-reflected light in to the optical fiber(s). Prevention of an optical back-reflection is conveniently done by angling the cleaved external fiber end at a small, approximately 8 degree angle to the perpendicular so that any back-reflected light is not coupled in to the optical fiber. Such an 8 degree angled end will have an optical back-reflection of order 0.0001% (or −60 dB), virtually eliminating the problem of optical back-reflection. All optical faces within the connection should also be angled at 8 degrees. The polished end of the connector body, containing a polished fiber end, is angled at 8 degrees, being referred to as an angle polished connector or APC. In addition, the internal fiber stub is provided angled at 8 degrees and also the external fiber must be angle cleaved at 8 degrees. Furthermore, the orientation of the two angled ends of the external fiber and the internal fiber stub should be controlled, with the orientation of the angling of the ends of the two fibers at 180 degrees to each other, such that the two angled ends mate closely together so that there is a minimal gap between the cores of the two fibers.

Similarly, multiple fibers entering a multi-fiber connector should exhibit low optical back-reflection. This is achieved by polishing the end of the connector with its multiple fibers at a 8 degree angle. The ends of the external fibers and the ends of the internal fiber stubs are also angled at 8 degrees and oriented so that the fibers mate together limiting the separation between the fibers, minimising optical loss.

In order to angle cleave the external fiber or fibers, a cleaver may be used in which the fiber or fibers are first clamped and then bent and/or tensioned prior to the application of a sharp blade to scratch the fiber. The pre-applied stress of the combination of bending and tensioning causes the scratch to propagate as a cleave. If the fiber or fibers are bent symmetrically, the resultant cleave or cleaves are perpendicular. If the fiber or fibers are bent non-symmetrically, the resultant cleave is angled. In these designs, the fiber is stressed by bending and tensioning prior to scratching. Oxford Fiber Ltd., Rugby, UK produces such a device under the trade name of Ox-SAC-08.

Alternatively, the cleaver which produces a perpendicular cleaved fiber end may be of the type whereby the stripped fiber is first held stationary between two rubber-coated clamps, scratched by passage of a sharp blade as it slides underneath the fiber and the cleave is effected by bending the fiber downwards, hence tensioning the pre-scratched fiber, so that it breaks at the position of the scratch. A typical design of such a cleaver is manufactured by Fujikura of Japan under the trade name of CT11. Non-perpendicular, angled ends may be effected using a similar tool in which the fiber is rotated in the clamps before bending. In this technique the fiber is scratched prior to application of the stress in the fiber.

In this invention, other designs of cleavers are also envisaged.

Although field-installable connectors eliminate the need to polish the ferrule in the field, terminating the external fiber to the connector can nevertheless be difficult in the field, where conditions often require the installer to perform this operation. The process is complicated by the need to use different tools. For example, after the fiber has been cleaved with a cleaver, the delicate cleaved end must be inserted in to the back of an opened connector, often by hand, with significant danger of the cleaved end becoming damaged by poor alignment with the back of the connector. Once the cleaved fiber is inserted in to the back of the connector and the external and stub fibers have been brought in to physical contact, the connector can be actuated, closing the housing of the connector down on to the external fiber and the internal fiber stub, whilst simultaneously aligning them, so bringing together the two fiber ends for the purpose of effecting transmission of light between the two fibers.

Therefore, an approach is needed for simplifying field terminations, in particular by controlling the insertion of the cleaved fiber end in to the back of the connector to avoid damage whilst, at the same time, minimising the number of tools and number of operations required to make this insertion. The present invention fulfils this need among others.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a system and method for terminating fibers in the field conveniently and precisely. Applicants recognize that field termination is simplified significantly if a single tool can be used to cleave the fiber and to insert the cleaved fiber in to the connector which can then be closed, bringing the two fibers in to optical alignment and close contact, enabling transmission of light between the two fibers. The closing of the connector can be achieved by using a spring action to trap the two fibers so that they come in to alignment and stay in position even with the application of external forces. This spring action can be effected by parts internal to the connector being snapped together or by an external application of a crimping a compressible member on the connector on to the fiber. This invention envisages connectorising a single fiber and also multiple fibers.

To this end, the present invention involves a device in which a fiber or fibers are placed in a holder and the holder is placed in a cleaver which cleaves the fiber or fibers with either a perpendicular or controlled angled end. The holder is then withdrawn along a channel within the cleaver, a connector is placed in the same channel and the holder and the fiber are slid along the channel so that the cleaved fiber end is inserted in to the back of the connector and the connector is actuated, making the optical join. The connector may either be placed within the channel of the device or the connector may be placed in a retainer which in turn is placed in to the channel. In this way, the fiber is always kept within the body of the device 200 which both cleaves the fiber or fibers and also acts to provide alignment of the cleaved fiber or fibers with the connector, so ensuring high reliability of fiber insertion, substantially reducing the chance of fiber damage during the process of connectorisation.

This approach not only simplifies field termination, but also enables the user to cleave a fiber, terminate it, and secure it to the connector using a single device and in just a few moves.

One aspect of the present invention is a device having a slidably mounted fiber retainer allowing the fiber or fibers to remain essentially along the same axis during the termination process.

In one embodiment, the device comprises: (a) chassis containing both a cleaving function and also features to allow slidable movement of the external fiber or fibers along the fiber's axis and also controlled placing of the end of the fiber(s) in a connector body, (b) a fiber retainer moving in a channel within the chassis, slidable along the axis of the fiber(s); (c) a cleaver aligned with the channel so that the fiber(s) may be slid in to position along their axis, cleaved and then slid away from the cleaver; and (d) a connector or a retainer holding a connector are placed in the same channel so that the cleaved external fiber end and the end of the fiber stub within the connector are co-linear and so can be brought together into substantially physical contact without danger of damage to the fiber or fibers.

Another aspect of the present invention is a method for cleaving, terminating, and crimping a fiber all in one operation using a single device. In one embodiment, the method comprises: (a) positioning a stripped external fiber or fibers in a fiber retainer slidably attached to the chassis to move along a channel parallel to the axis of the fiber or fibers; (b) sliding the stripped fibers and their retainer to a first position 260 which closely adjoins the cleaver; (c) cleaving the bare portion of the fiber or fibers to form a cleaved end or ends; (d) sliding the fiber retainer away from the cleaver along the axis of the fiber(s); (e) causing to be presented a connector, either separately or held in a connector holder, either of which are placed in the channel of the chassis; (f) sliding the fiber retainer to a second position along the channel of the chassis, thereby causing the cleaved end or ends to extend into the guide of the connector so that there is substantially physical contact between the cleaved external fiber or fibers and the internal fiber stub(s) present in the connector; (g) actuating the connector while the fiber retainer is at the second position to clamp the cleaved end or ends in the connector and optionally crimping a deformable member which acts to further attach the connector to the fiber cable.

### BRIEF DESCRIPTION OF THE DRAWINGS

FIG. 1a shows an isometric drawing of the device 200 of the present invention with the stripped fiber or fibers held in a fiber retainer placed within the channel aligned to the cleaver.

FIG. 1b shows a schematic top view of FIG. 1a.

FIG. 2 shows the device of FIG. 1a, FIG. 1b with the fiber retainer 202 and stripped fiber 203b slid in to the first position adjoining to the cleaver so that the fiber or fibers may be cleaved.

FIG. 3 shows the device of FIG. 1 with the cleaved fiber and its cleaved end 210 held within the fiber retainer 202 which has been withdrawn from the cleaver 204 along the channel 205.

FIG. 4a shows a view of the device 200 with a connector 301 placed in the channel 205 of the device.

FIG. 4b shows a schematic top view of the device of the fiber retainer 202 containing the fiber or fibers with their cleaved ends 210 slid in to a second position 270 so that the cleaved fiber or fibers are guided into the connector.

FIG. 4c shows a schematic top view of the device of the fiber retainer 202 containing the cleaved fiber or fibers slid in to a third position 272 against a stop 280 so that there is a pre-determined distance between the fiber retainer and the connector.

FIG. 5a shows a schematic top view of the device of the device with a fiber retainer 202 and a connector 301 placed in a connector retainer 302 which is placed in the channel 205 of the device.

FIG. 5b shows a schematic top view of the device showing the fiber retainer containing the cleaved external fiber or fibers slid in to a second position 271 against the end of the connector retainer so that the cleaved fiber or fibers are guided in to the connector.

FIG. 5c shows a schematic top view of the device of the fiber retainer containing the cleaved fiber or fibers slid in to a third position 273 against a stop 281 so that there is a pre-determined distance between the fiber retainer and the connector retainer and the end of the connector.

FIG. 6 shows a schematic top view of the device showing dies 303a, 303b, which effect the closure of the connector to secure the cleaved fibers in optical contact with the connector.

FIG. 7a shows a schematic of a connector 301 with an internal fiber 405 in a ferrule 401 with a polished end 402 and the end of the internal fiber stub 403.

FIG. 7b is a schematic view of the connection between the external fiber 203b and its cleaved end 210 and the end 403 of the internal fiber stub 405 of the connector, whereby the fiber connection is made at a point 415 external to the ferrule of the connector in a V-groove 410, channel, tube or otherwise and the cleaved point is visible through a window 411.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

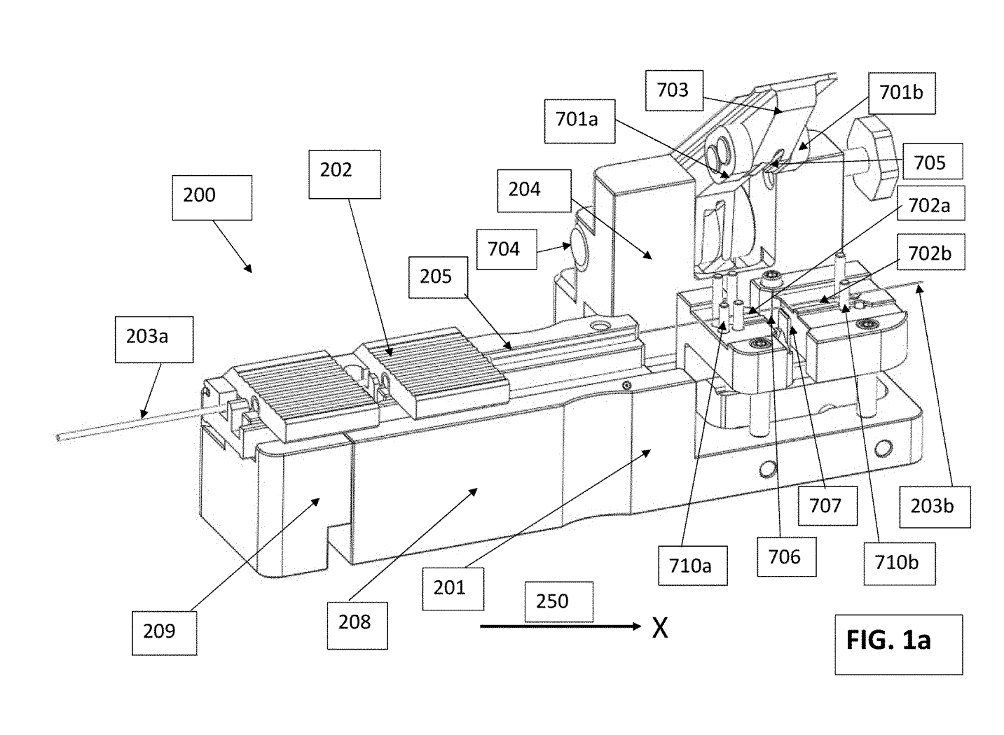

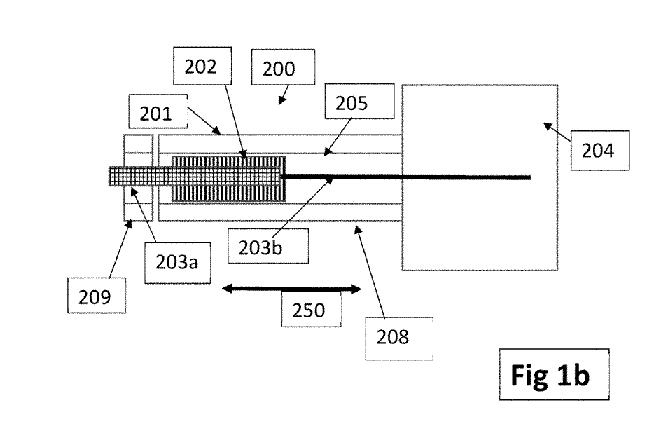

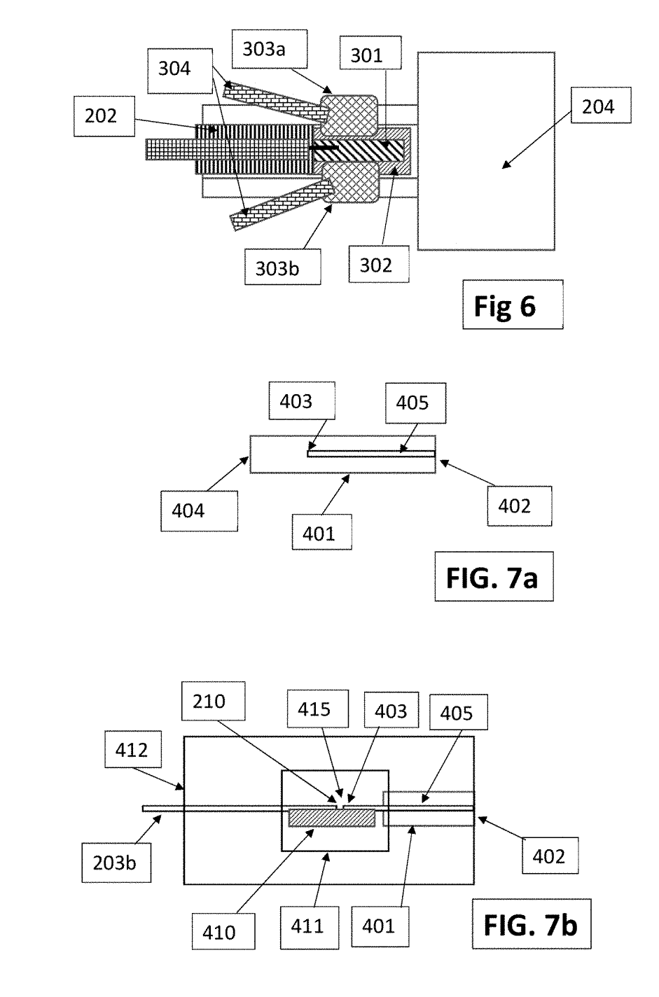

Referring to FIGS. 1-7, one embodiment of the device 200 of the present invention is shown. The device comprises a chassis 201; a fiber retainer 202 slidably attached to the chassis to slide along the channel 205 in the direction of the x axis 250; an optical fiber or fibers 203a stripped to reveal the bare glass of the optical fiber 203b; a cleaver 204 which is contained within the chassis 201.

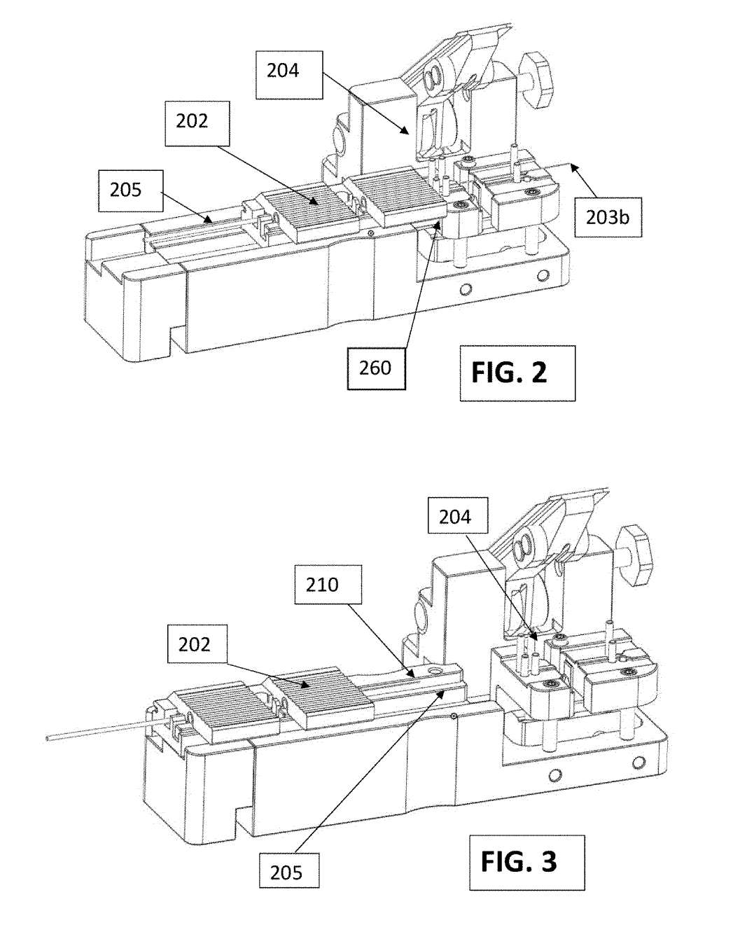

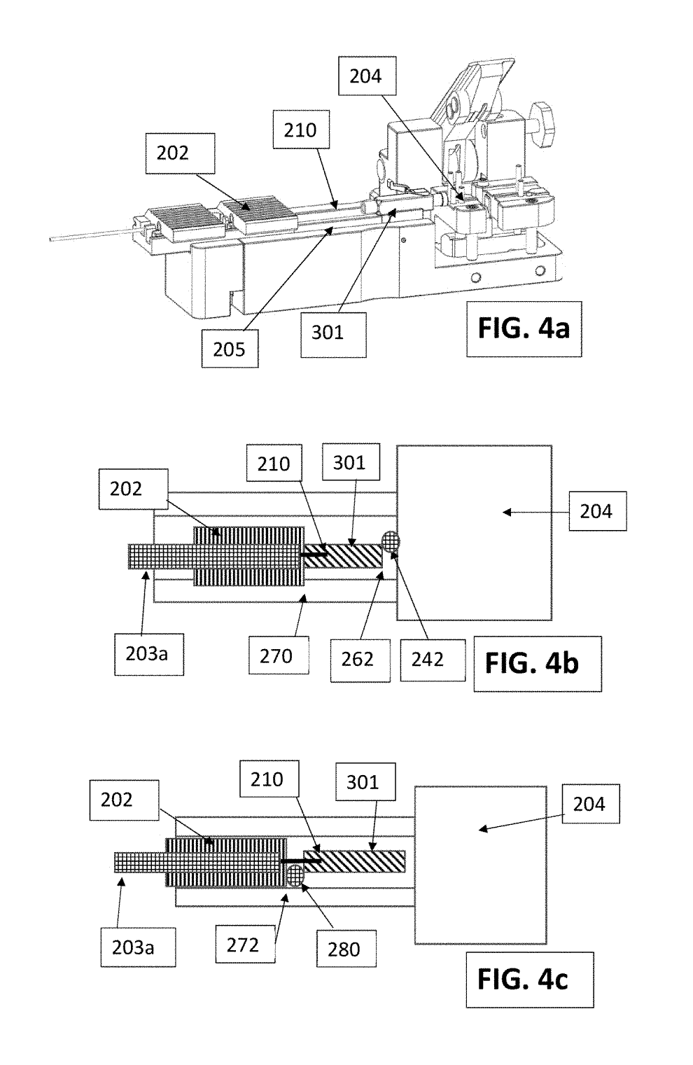

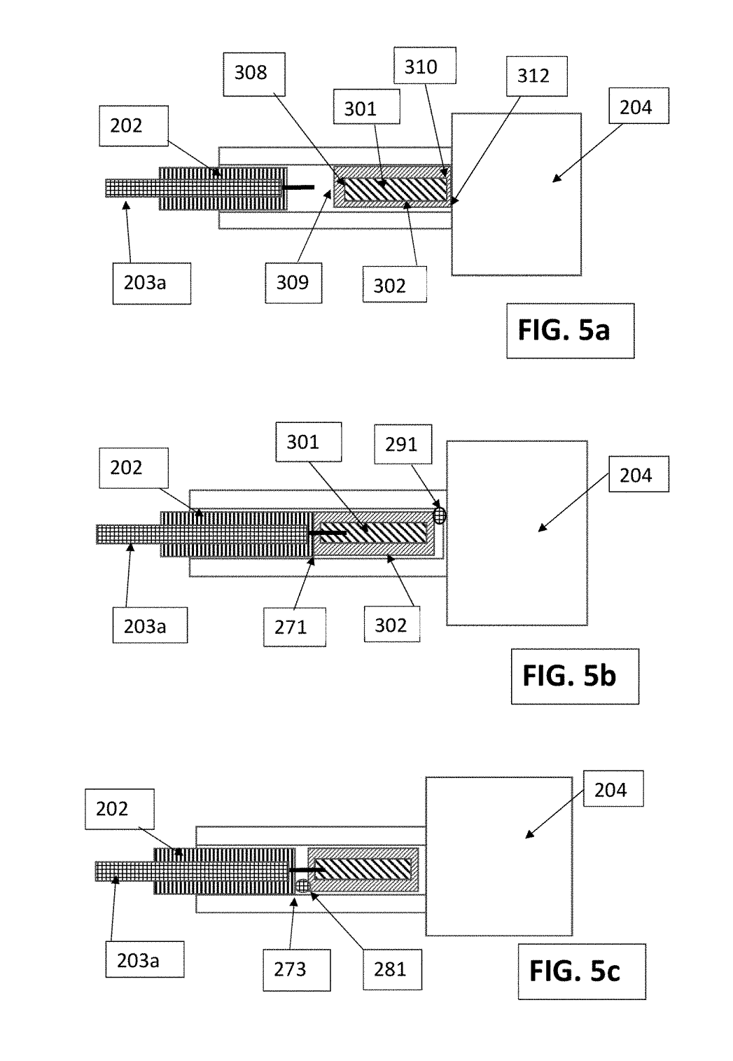

The device of the present invention is configured to terminate a fiber to a connector. In one embodiment, the method comprises (a) positioning a stripped fiber or fibers 203a, 203b in the device 200 having a bare portion 203b and a buffered portion 203a; (b) securing the fiber 203a, 203b to a fiber retainer 202 slidably attached to the chassis 201 such that the fiber retainer is moved along the x axis 250, the end of which is stopped at a first position 260 (see FIG. 2) on the x axis and the bare portion of the stripped fiber 203b extends in to a guide within the cleaver 204; (c) cleaving the bare fiber portion to form a cleaved end 210; (d) sliding the fiber retainer 202 away from the cleaver 204 along the x axis; (e) causing to be presented in the fiber channel 205 either a connector 301 (see FIG. 4a, FIG. 4b, FIG. 4c) or a connector held within a connector retainer 302 (see FIG. 5a, FIG. 5b, FIG. 5c), either of which are located in the channel 205 of the chassis 201 and whereby the polished end of the connector (402 in FIG. 7) is adjacent to the cleaver 204 and the open end of the connector 404 with its access to the fiber stub 403 is adjacent to the fiber retainer; (f) sliding the fiber retainer 202 so that its end is stopped at a second position 270 along the x axis, thereby causing the cleaved end or ends of the external fiber(s) to extend into a guide in the connector; and (g) actuating the connector with a connector actuation device to clamp the cleaved end inside the connector while the fiber retainer 202 is at the second position 270.

Details of the device and method are considered in detail below.

The chassis 201 functions to hold the fiber retainer, connector and/or connector retainer, cleaver and connector actuation device in relative position to each other. The chassis may be in any form suitable for holding the components in relative position to each other. For example, the chassis may be a machined, extruded or cast piece with or without additional parts, a planar platform, or it may comprise rails or elongated members defining a framework for supporting the various components and allowing relative slidable movement of such components.

In the embodiment shown in FIG. 1a, FIG. 1b, the chassis 201 is essentially a machined assembly made up of a cleaver 204 and of a channel 205 which defines the x axis 250. In FIG. 2, the fiber retainer 202 moves along the channel 205 to a first position 260 so that the fiber or fibers may first be cleaved, then retracted (FIG. 3) so that the connector or the connector held in a connector retainer can be placed in the channel 205 (see FIG. 4a and FIG. 5a). The fiber retainer is advanced to a second position 270 along the channel (see FIG. 4b) so that the cleaved external fiber or fibers are inserted in to the connector to make contact with the internal fiber stub(s) which connector is then actuated to form a firm optical connection between the connector and the cleaved fiber ends.

We will now more closely define the constituent parts and method of operation of the device 200 and associated embodiments of the invention, including the optical fiber or fibers, chassis, channel, fiber retainer, cleaver, connector and connector retainer.

In one embodiment, the chassis 201 has an open channel 205 for facilitating the sliding movement of the fiber retainer 202 and the stripped optical fiber or fibers so that they are properly aligned to the cleaving mechanism. The channel 205 also serves to locate the connector which may or may not be mounted in a connector retainer. Since the fiber retainer and the connector or connector mounted in a connector retainer are co-linear along the channel 205, sliding movement of the retainer towards the connector will ensure that the cleaved fiber end(s) will line-up and locate accurately to the guide within the connector allowing optical connection to be made between the cleaved fiber end and the fiber stub or stubs internal to the connector.

The channel 205 should extend sufficient distance from the cleaver to allow space for the placing of the connector and/or connector insert between the cleaved fiber end held in the fiber retainer and the cleaver. In one embodiment, the channel is continuous, existing between the edge of the cleaver and the extremities of the fiber retainer when it is pull along the channel to make way for the connector and/or the connector retainer. The channel preferably should be of sufficient length to support the fiber retainer and prevent it falling out of the chassis. However, there are circumstances in which the fiber retainer is relatively long and therefore the channel 205 would have to be even longer to support the fiber retainer in the channel and this might have the deleterious effect of increasing the size and weight of the device 200. To avoid excessive length of the channel 205, and the consequent increase in size and weight, in another embodiment, the channel 205 may be constructed in two or more parts. One part of the channel 208, located close to the cleaver, provides support and alignment for the fiber retainer and so the fiber as it is cleaved and also provides support and alignment for the connector and/or connector retainer. A second part of the channel 209, as shown in FIG. 1b, can be disposably extended from the first part of the channel, by sliding, swinging, temporary attachment or otherwise, whereby the second part of the channel provides support and/or guidance for the end of the fiber retainer furthest from the cleaver when it is retracted. The first and second parts of the channel do not have to be continuously connected, except by the sliding, swinging or temporary attachment mechanism.

In one embodiment, there is a stop in the channel to prevent the fiber retainer being moved along the channel too far away from the cleaver, avoiding the fiber retainer from falling out of the channel. This stop may be fixed or it may be settable by the user.

The fiber retainer 202 functions to grip the buffer 203a around the fiber 203b and prevent the external fiber from sliding axially or rotating. The term “fiber retainer” is used broadly in this context and refers to a mechanism for holding something. Suitable fiber retainers includes, for example, clamps, clips, wedges, set screws, vices or any other device suitable for securing a buffered fiber. In one embodiment, the retainer 202 is a clamp having one or more lids which are pivotally mounted and biased closed. The retainer may also have one or more lids which may or may not be clamping, for instance one or more of the lids may raise in response to bowing of the fiber for instance to indicate when the external cleaved fiber comes in to contact with the fiber stub within the connector. The fiber retainer 202 is slidably attached to the chassis. The term “attached” as used in this context refers to either directly or indirectly attached. For example, the fiber retainer may be placed directly in the chassis as in the embodiment of FIG. 1. Alternatively, the fiber clamp may be attached to the chassis via intermediate components.

The cleaver 204 functions to cleave the fiber in a precise and predictable way. Such cleavers are known and include, for example, perpendicular and angled cleavers.

In one embodiment shown in FIG. 1a, a cleaver 204 is used. Specifically, the cleaver 204 comprises two deformable clamping rings 701a, 701b, which trap the stripped fiber 203b between the deformable clamping rings and two clamping surfaces 702a, 702b, clamping the fiber(s) at two clamping points, and where the deformable rings are typically fabricated from rubber, EPDM, polyurethane or other deformable material. The clamping rings are mounted on an anvil 703 which is swung towards the clamped fiber around a pivot 704, so clamping the fiber(s) at the two clamping points. The anvil also includes a contact ridge 705, located between the clamping points, which serves to deflect the clamped fibers in to a clamping hole 706 which separates the two clamping surfaces. The fiber(s) are consequently bent and tensioned. The contact ridge 705 of the anvil further deflects the clamped and bent and tensioned fiber(s) so that they come in to contact with a sharp blade 707 made of diamond or similar hard and sharp material. The fiber is scratched by its contact with the blade and the stress which has been applied to the fiber causes the fiber to cleave. In those circumstances, where the fiber is bent by the contact ridge at a position laterally offset from the blade, the subsequent cleave will be non-perpendicular i.e. it will be angled. Further detail can be gained from inspection of U.S. Pat. No. 8,069,691.

In another embodiment of the cleave 204, multiple fibers are clamped, deflected, so tensioning them and subsequently scratched and cleaved, generating angled cleaves.

In another embodiment, where the contact ridge bends the fiber(s) at two points symmetrically about the blade, the cleaver 204 will cleave fiber or fibers with substantially perpendicular ends.

The cleaver 204 also contains alignment means so that the external fiber(s) can be aligned with the sharp blade and the clamping means, alignment means include the use of guides formed between pairs of closely spaced dowels 710a, 710b, to control the pointing of the fiber(s). The channel 205 of device 200 is located so that the fiber retainer 202 aligns the fiber or fibers so that they are acted upon by the contact ridge and clamping means of the cleaver 204.

As shown in FIG. 7a, the connector 301 typically contains an optical fiber stub 405 which is located within a ceramic, metal or plastic ferrule 401. The fiber is typically glued into position within the ferrule. One end of the ferrule/fiber combination 402 is factory-polished to allow later mating with other connectors. The other end 403 of the ferrule fiber typically terminates within the body of the ferrule or just outside. The end of the fiber stub 403 is typically cleaved during preparation of the connector to allow optical connection with the external fiber. The stub fiber may be square cleaved or it may be angled cleaved to reduce optical back-reflection. The ferrule of the connector is located within an housing 412 which provides mechanical handling of the assembled connector and normally contains a guide so that the external fiber can be aligned with the back of the connector.

Some connectors are designed to connectorise single fiber and these are know as LC, SC, E2000 and other types of connector. Alternatively, some connectors are designed to connectorise multiple fibers, often presented in ribbon format, and these are often referred to as MT connectors.

Some connectors are known in which the fiber stub 403 terminates outside of the ferrule 401, as shown in FIG. 7b. The connection between the fiber stub 403 and the external cleaved fiber end 210 is made at a point 415 in a V-groove 410. The connector is held open using a key which allows the cleaved fiber 210 to be inserted. Once optical contact has been made between the fiber stub 403 and the cleaved end 210, often as indicated by the bowing of the external fiber, the connector is closed by withdrawal of the key, so clamping together the two fiber ends and ensuring optical contact between the two fiber ends. Examples can be found in the FO Connector from R&M, Wetzikon, Switzerland.

If the connector is an APC-type connector, it is important to hold the connector in a particular position because the connector contains an angle-cleaved fiber stub (not shown). Because the stub is angle cleaved, the position of the connector is critical to effect a good optical coupling. That is, if the connector is rotationally misaligned, the angle cleave of the stub will interfere with the terminating external fiber, camming it away and thus creating an air gap and, hence, insertion loss. Consequently, the connector retainer 302 must hold the connector 301 secure, and/or the connector must be held secure, to ensure the correct orientation of the angle cleave relative to the chassis.

The connector retainer 302 may be any mechanism capable of holding a connector. Suitable retainers include, for example, clamps, clips, wedges, set screws, vices, straps, hook and loop connectors and even adhesive means, such as tape. If the connector is present without the presence of a connector retainer, the connector should be held secure within the channel 205 using a fixture or other attachment means.

In one embodiment, the connector retainer 302 also comprises a damper 303a, 303b for compressing the connector to actuate the clamping mechanism of the connector, thereby securing the external fiber to the connector. Such compression is a well known technique for actuating field-installable connectors. Traditionally, such an operation was performed using an actuation tool resembling pliers. The device of the present invention, however, is able to perform this function, along with the process of cleaving the fiber as discussed above and optionally crimping the compressible member of the connector as described below. To this end, in one embodiment, the damper 303 comprises first and second dies 303a, 303b. The dies are operatively connected to one or more levers 304, such that moving the levers 304 causes the dies to move toward each other, thereby actuating the clamping mechanism of the connector.

In the embodiment shown in FIG. 2, the fiber retainer is positioned at a first position 260. Consequently, the fiber 203b is cleaved with the cleaved end 210 at a pre-determined distance from the end of the fiber retainer. Consequent to this, depending on the positioning of the fiber coating within the fiber retainer, the fiber is cleaved at a pre-determined distance from the end of the fiber coating 203a. The fiber coating may protrude beyond the end of the fiber retainer, or vice-versa. The fiber retainer is conveniently positioned at the first position 260 by pushing the end of the fiber retainer against a side wall of a part of the cleaver 204. However, in other embodiments, the fiber retainer is positioned at 260 by pushing up against stops placed within the channel 205 or otherwise. The fiber retainer may be positioned by manual pushing against a stop or by other means such as magnetic or other latching or adhesive or other methods.

In the embodiment shown in FIG. 4b, after the fiber has been cleaved and the fiber retainer withdrawn, a connector 301 may be introduced in to the channel 205 between the cleaver and the fiber retainer. The connector may be supported in the channel by a support which may be placed in the channel or be an integral part of the chassis. Subsequently, the fiber retainer is pushed against the connector body 301 to define a second position 270. The support for the connector should not impede movement of the fiber retainer. The cleaved fiber protrudes from the end of the fiber retainer by a predetermined distance, therefore the cleaved fiber end extends by the pre-determined distance in to the back of the connector 301, enabling accurate contacting between the cleaved fiber end and the internal fiber stub of the connector.

In one embodiment, as shown in FIG. 4b, the polished end of the connector 402 is pushed against a stop 242 which prevents movement of the connector; this stop may be provided by the side of the cleaver. Alternatively, stop 242 may be a separate physical stop which is placed in to the channel whereby the stop 242 is temporarily removable to allow the close approach of the fiber retainer 202 to the cleaver 204 during the cleaving step. The physical stop may be of significant length along the chassis so that the polished end of the connector 402 is widely removed from the cleaver, whilst the connector and the fiber retainer remain in the channel 205 which may have been extended by the use of the telescopic section 209 of the fiber channel. In this way, optical connections can be made to the polished end of the connector whilst the connector is confined within the body of the chassis. In particular, the polished end of the connector can be mated with a further optical fiber patchcord which has been connected to a visible light source such as a HeNe light laser. Visible laser light is injected in to the polished end of the connector, travels along the fiber stub 405 and exits the fiber stub at its pre-prepared end 403, generating a bright visible spot which is created because the laser reflects off the end of the fiber stub. The bright spot can be viewed through a transparent window 411 in the connector housing 412. When the external fiber is pushed in to the back of the connector, as shown in FIG. 4b, the visible bright laser spot is extinguished if there is a good optical connection between the end of the cleaved external fiber 210 and the end of the internal fiber stub 403 because the laser light is no longer reflected, rather it traverses in to the external fiber. This technique allows the user to confirm that a good optical connection has been made. In contrast, if the light is not extinguished, a poor connection has been made.

The connector can be secured within the channel 205 of the cleaver, as described above. Alternatively, the connector can be free to slide so that it pushes up against a stop 240 in the cleaver which may be a part of the cleaver or some other hindrance placed in the channel 205. In this case the connector will be trapped between the fiber retainer and the stop 240, allowing accurate insertion of the cleaved fiber end in to the connector. The protrusion of the cleaved fiber beyond the end of the fiber retainer as it enters the fiber connector can be exact so that the cleaved fiber end and the end of the fiber stub contact exactly. Alternatively, the protruding fiber end may be slightly longer than the length required to make exact contact between the two fibers ends. As the fiber retainer is pushed against the connector, the two fiber ends will make physical contact and further movement will cause the external fiber to bow, indicating that the contact has been made. A door or other indicator within the fiber retainer can be actuated by the bowing of the fiber to indicate that this contact has been made.

In another embodiment, shown in FIG. 4c, there need be no direct contact between the fiber retainer and the connector in the case where the fiber retainer is slid against a stop 280 in the channel 205, to place the fiber retainer 202 in a third position 272 and whereby the connector is fixed relative to this stop. In this way the external cleaved fiber end and the internal stub are separated by a defined distance. The stop 280 is provided by a physical stop in the channel and the stop is positioned so that the cleaved end of the fiber contacts the internal stub in the connector when the cleaved fiber and the connector are slid together. In this embodiment, prior to fiber insertion in to the connector, the stop 280 can be temporarily removed from the channel to allow the fiber retainer to approach the cleaver to its first position so that the cleave can be carried out.

Similarly, in another embodiment, as shown in FIG. 5b, after the fiber has been cleaved and the fiber retainer has been withdrawn, the connector body 301 is placed within a connector retainer 302 and introduced in to the channel 202 in the chassis. In this embodiment, the connector body 301 is secured at a defined position within the connector retainer, either by securing the connector body within the retainer or slidably such that the connector body is pushed against an end stop 310 of the connector retainer. The end of the connector 312 may be pushed up against the side of the cleaver or against a stop 291, so preventing movement of the connector retainer and the connector. The fiber retainer 202 is pushed up against the end of the connector retainer 309 such that the fiber retainer 202 is stopped at a defined second position 271. The external cleaved fiber end 210 protrudes by a defined distance from the end of the fiber retainer and is inserted a defined distance in to the back of the connector, causing optical connection to be made between the cleaved fiber and the internal fiber stub. Alternatively, the protruding fiber end may be slightly longer than the length required to make exact contact between the two fibers ends. As the fiber retainer is pushed against the connector, the two fiber ends will make physical contact and further movement will cause the fiber to bow, indicating that the contact has been made. A door or other indicator with the fiber retainer can be actuated by the bowing of the fiber to indicate that this contact has been made.

In another embodiment, the stop 291 may be of significant length along the chassis so that the polished end of the connector 402 is widely removed from the cleaver, whilst the connector and the fiber retainer remain in the channel 205 which may have been extended by the use of the telescopic section 209 of the fiber channel. In this way, optical connections can be made to the polished end of the connector whilst the connector is confined within the body of the chassis. In particular, the polished end of the connector 402 can be mated with a further optical fiber patchcord which has been connected to a visible light source such as a HeNe light laser. Visible laser light is injected in to the polished end of the connector, travels along the fiber stub 405 and exits the fiber stub at its pre-prepared end 403, generating a bright visible spot which can be viewed through a transparent window 411 in the connector housing 412. The visible spot is created because the laser reflects off the end of the fiber stub. When the external fiber is pushed in to the back of the connector, as shown in FIG. 5b, the visible bright laser spot is extinguished if there is a good optical connection between the end of the cleaved external fiber 210 and the end of the internal fiber stub 403 because the laser light is no longer reflected, rather it travels in to the external fiber. This technique allows the user to confirm that a good optical connection has been made. In contrast, if the light is not extinguished, a poor connection has been made.

Similarly, as shown in FIG. 5c, in another embodiment, the fiber retainer and the connector retainer can be separated by a pre-defined distance by the fiber retainer being pushed against a stop at 281, being located at a third position 273, such that the external cleaved fiber and the internal fiber stub are separated by a defined distance, allowing controlled physical contact to be made therebetween.

Device 200 facilitates a method of terminating any field installable connector using just a single device in essentially one operation. More specifically, referring FIGS. 1-7, the steps of the method of the present invention are described in detail with respect to a connector termination.

First, a boot device and/or strain relief sleeve is slid over the fiber and/or cable to be terminated. Optionally a crimp sleeve may be then be slid over the fiber and cable. The buffered fiber is stripped and placed in the fiber retainer so that the stripped fiber 203b protrudes beyond the end of the fiber retainer 202.

The fiber retainer 202 is slid along the channel 205 so that it butts against the cleaver 204. The fiber retainer is located at a first position 260 in the channel. The striped external fiber 203b extends in to the cleaver mechanism. The cleaver is actuated by depressing an anvil arm, clamping, bending, tensioning the fiber and defecting the fiber on to a sharp blade so that the fiber is scratched and so cleaves under the applied stresses. The anvil arm is released so that the cleaved fiber is free to be withdrawn.

The fiber retainer 202 is slid away from the cleaver 204 along the channel 205. The retainer is slid far enough away from the cleaver so that there is space for an optical fiber connector or a connector held in a connector retainer to be placed in the channel between the cleaver and the external cleaved fiber end 210 (located in the fiber retainer) and preferably to a stop to limit its sliding.

A connector 301 is placed in a connector retainer 302 and the connector retainer is placed in the channel 205 between the cleaver and the cleaved end of the fiber secured in the fiber retainer. Preferentially, the connector body is fixed to the connector retainer, either by means of a fastening or by magnetic or other means so that there is a defined distance between the end of the connector 308 and the end of the connector retainer 309. The connector retainer 302 is preferentially secured in the channel 205 so that it is in contact with the edge of the cleaver 204 so that there is a defined distance between the end 308 of the connector 403 and the edge of the cleaver. The connector is held open so that a fiber can be inserted, for instance using a key as found in the FO Connector from R&M, Switzerland.

The fiber retainer is slid towards the end 309 of the connector retainer, the fiber holder butting up against the end 309 of the connector retainer 302, the fiber retainer finding a second position 271 in the channel. As the fiber retainer is pushed against the back of the connector retainer, the cleaved fiber end 210 which protrudes from the fiber retainer is guided in to the back of the connector because both are in line due to their alignment in the channel 205. At the point, or just before, that the fiber retainer 202 and the connector retainer 302 come in to contact, the cleaved fiber end 210 and the end of the fiber stub 403 come in to contact. Further motion together of the fiber retainer and the connector retainer/connector will cause the fiber 203a, 203b to bow, indicating that physical contact between the two fiber ends has been made. The fiber retainer is held against the end of the connector retainer, by manual means or by magnetic or other adhesive means, ensuring that physical contact between the two fiber ends is maintained.

With the external cleaved fiber inserted in to the connector 301 and the external fiber and internal fiber stub in contact with each other, the connector 301 is actuated to secure the fiber to the connector. To this end, the key may be removed from the connector, allowing the connector to close, so clamping together the cleaved fiber end and the fiber stub. In this way, the fiber is held in intimate contact with the fiber stub by virtue of a clamping mechanism in the connector, which applies a radial force to the terminating fiber to secure it to the connector. Advantageously, this clamping mechanism facilitates straightforward field assembly by obviating the need to handle epoxy and for curing ovens during field termination.

In the case where a crimp sleeve has been placed over the fiber and cable, the connector can be further secured to the fiber and cable. Squeezing the levers 304 causes the crimp jaws 303a, 303b to move together, thereby crimping a compressible member of the connector or the crim sleeve disposed therebetween to the buffered fiber. The compressible member may be, for example, a compressible sleeve or a plunger. In this way, the device 200 enables a user to cleave a fiber, actuate the connector to clamp the fiber, and optionally to crimp the compressible member around the fiber using one tool. Furthermore, in one embodiment, the clamping and crimping functions are performed simultaneously.

It should be understood that the description above provides illustrative embodiments of the present invention and other embodiments exist.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of terminating an optical fiber or fibers in a connector or connectors using a device having a chassis, external fiber or fibers being stripped to present a bare fiber portion or portions extending from a coated portion or portions, said method comprising:
(a) positioning a stripped external fiber or fibers in a fiber retainer slidably attached to the chassis to move along a channel parallel to the axis of the fiber or fibers; (b) sliding the stripped external fibers and their retainer along the channel to a first position which closely adjoins a cleaver and cleaving the bare portion of the fiber or fibers to form a cleaved end or ends;
(c) sliding the fiber retainer with its cleaved external fiber ends away from the cleaver along the channel;
(d) causing to be presented a connector or connectors, either separately or held in a connector holder or holders, either of which are placed in the channel;
(e) sliding the fiber retainer along the channel towards the cleaver to a second position, thereby causing the cleaved external fiber end or ends to extend into a guide of the connector so that there is optical contact between the cleaved external fiber or fibers and a fiber stub or fiber stub(s) present internally in the connector; and
(f) actuating the connector, while the fiber retainer is at the second position, to clamp together in the connector the cleaved external fiber end or ends and internal fiber stub or stubs to make an optical connection and optionally crimping a deformable member which acts to further attach the connector to the external fibers and their coated, protective cabling.

2. A device for terminating an optical fiber or fibers in a connector or connectors, said device comprising:
a cleaving device;
a fiber retainer which holds a stripped fiber or fibers which are to be cleaved;
a channel running substantially parallel to the optic axis of the fiber or fibers along which the fiber retainer may slide;
a locating portion, located between a cleaver and the fiber retainer and located substantially in the channel, in to which the connector or connectors may be placed and towards which the fiber retainer with its cleaved fiber or fibers may slide to effect optical connection between the cleaved fibers and connector or connectors; and
a device for making permanent the optical connection between the cleaved fibers and the connector or connectors.
